(19) United States
(12) Patent Application Publication
(10) Pub. No.: US 2002/0173417 A1
(43) Pub. Date: Nov. 21, 2002

(54) High gain short length optical amplifiers

(76) Inventors: John D. Myers, Hilton Head, SC (US); Michael J. Myers, Hilton Head, SC (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/113,395

(22) Filed: Apr. 1, 2002

Related U.S. Application Data
(60) Provisional application No. 60/280,027, filed on Mar. 30, 2001.

(51) Int. Cl. C03C 3/095

(52) U.S. Cl. 501/64

(57) ABSTRACT

A new multi-component optical amplifier glass, composed of multiple glass formers has been developed which displays bandwidths significantly larger than currently possible using silica-based or phosphate based, erbium doped fibers. Initial results indicate that using this material, one could double the bandwidth of existing optical amplifiers. This greatly increased spectrum combined with higher emission cross sections and the ability to go to higher doping concentrations, compared with silica-based fibers, make this new optical amplifier very attractive for increasing the transmission capacity of wavelength-division-multiplexing (WDM) transmission systems using optical fibers.

The present application claims priority to United States Provisional Patent Application No. 60/280,287, filed on Mar. 30, 2001.

### BACKGROUND OF THE INVENTION

The present invention relates generally to an improved light amplifier for use with wavelength-division-multiplexing (WDM) transmission systems using optical fibers or equivalent light transmitting devices in WDM transmission systems. More specifically, the present invention relates to a light amplifier capable of amplifying light at a broader range of wavelengths than that of known light amplifiers.

WDM transmission systems use optical glass fibers to transmit light across long distances thereby transmitting data signals between two places. Generally, light beams generated by lasers or similar sources of light are transmitted through the optical fibers from one position to another position. The light beams are generated to transfer voice signal and electronic data between the two positions. However, the light beams are known to lose strength through dispersion and other types of energy dissipating factors known in the art of WDM transmission systems. Therefore, to transfer light across long distances, it is necessary to introduce optical amplifiers to refocus and amplify the light signals. These optical amplifiers are typically made from a doped glass having, for example, phosphate glass with an erbium, doping element. However, optical amplifiers of this type are known to cause a bottleneck in the transfer of light through the optical glass fibers due to the narrow spectrum of light these amplifiers are capable of transmitting.

Transmitting light in a broad spectrum is desirable to optimize the amount of light, i.e. information, transmitted through the optical glass fibers in WDM transmission systems. The narrower the transmission spectrum is, the smaller the amount of information that can be transmitted through the optical fibers. Therefore, it would be desirable to provide improved optical amplifiers capable of amplifying light beams at broader wavelength spectrums than currently known amplifiers to thereby increase the amount of information capable of being transmitted through a WDM transmission system.

### SUMMARY OF THE INVENTION

A composition of glass is disclosed having a mixture of glass formers and a lasing ion. The mixture of glass formers includes at least three glass formers selected from the group of oxides of: silicon, germanium, boron, phosphorus, aluminum, tellurium, lanthanum, and lead. Each of the glass formers is present in a mole percent amount ranging from about 15% to about 45% based on the total moles of the glass formers included in the glass composition. The lasing ion is selected from the rare earth elements, also known as the lanthanide series of elements. The lasing ion includes at least one of lanthanide, cerium, praseodymium, neodymium, promethium, samarium, europium, gadolinium, terbium, dysprosium, holmium, erbium, thulium, ytterbium, and lutetium present in a weight percent amount ranging from about 0.1% to about 30% based on the total weight of the glass composition.

The rare earth lasing ion in combination with a mixture of glass formers, included in the ranges set forth above, have proven to increase the spectrum of light wavelength transmission by the optical amplifier. The optical amplifier is capable of amplifying by as much as double over the spectrum known to be amplified by current optical amplifiers doped with, for example, erbium lasing elements. By doubling the transmission spectrum of currently available devices, the transmission capacity of WDM transmission systems is increased significantly enabling thereby significant increases in the amount of information that can be transmitted. Therefore, not only are these systems made more efficient, these WDM systems may now be used in a wider range of applications.

### BRIEF DESCRIPTION OF THE DRAWINGS

Other advantages of the present invention will be readily appreciated as the same becomes better understood by reference to the following detailed description when considered in connection with the accompanying drawing wherein:

FIG. 1 is a graph comparing the transmission spectrum of a glass composition according to the present invention doped with erbium with the transmission spectrum of a commercially available phosphate glass doped with erbium.

### DETAILED DESCRIPTION OF THE PREFERRED EMBODIMENT

The present invention is directed toward broad emission band glass having a new doped, multi-component glass former proven to increase the transmission spectrum over prior art glass. A new rare earth element doped multi-component glass has been developed that displays an extended bandwidth of the lasing element emission spectra that is significantly broader than present silica or phosphate multi-component glasses doped with erbium. In its basic form, this new glass is a hard, durable material with excellent characteristics in terms of low thermal expansion and high rupture strength. The further development of this glass to maximize the emission cross section and minimize back-transfer, and other loss mechanisms is ongoing. By virtue of the compositional improvements, a transmission spectrum having up to twice the transmission spectrum of prior art glass has been established.

The subject inventive glass includes at least three glass formers selected from the oxides of: silicon, germanium, boron, phosphorus, aluminum, tellurium, lanthanum, and lead. The glass further includes at least one lasing ion selected from the Lanthanide series. The glass may also include glass modifies from the alkali or alkaline earth metals.

Each of the glass formers is preferably present in a mole percentage amount of from 15% to 35% based on the total moles of glass formers, or alternatively approximately equal mole percentages of the total of the glass formers. However, where lanthanum oxide (La₂O₃) is used, the mole percent of lanthanum oxide may range from between 15% to 45% of the total moles of glass formers included in the glass composition.

The lasing ion may be any lasing ion selected from the Lanthanide series, and is preferably erbium oxide (Er₂O₃). The lasing element preferably is from about 0.1% to 30% by weight, and more preferably. The lasing element preferably is present in the amount of from about 1% to 8% based on the total weight of the glass composition. The glass composition may optionally include modifiers known to improve the ability for ion exchange and chemical durability, such as lithium oxide (Li₂O) or magnesium oxide (MgO). The glass modifiers are preferably present in an amount of from about 0% to 30% by weight based on the total weight of the glass composition. The most preferred glass modifier is lithium oxide, wherein the preferred range of lithium oxide (Li₂O) is from about 5% to 15% by weight of the glass composition when used.

The glass composition may also optionally include a sensitizing element, such as ytterbium oxide (Yb₂O₃) or thulium oxide (Tm₂O₃), wherein the range of the sensitizing element ranges between about 0% to 30% based on the total weight of the glass composition and more preferably between about 1% to 10%. Further, the glass composition may optionally include an antisolarant to reduce the browning affect of ultra violet light and nuclear radiation on the glass. The antisolarant preferably is selected from the group including niobium oxide (Nb₂O₅), cerium oxide (CeO₂), europium oxide (Eu₂O₃), antimony oxide (Sb₂O₅), titanium oxide (TiO₂), and mixtures thereof. In a preferred embodiment, the antisolarants are a mixture of niobium oxide and cerium oxide. The total amount of antisolarants preferably ranges from about 1% to 5% by weight based on the total weight of glass composition.

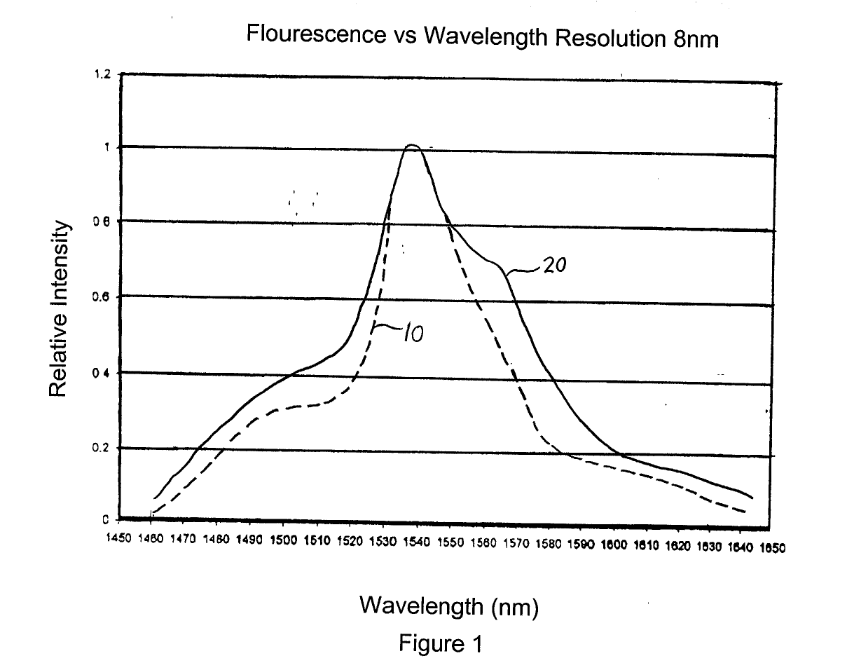

FIG. 1 illustrates the broadening of the erbium emission spectra associated with the improved optical amplifiers of this invention compared to commercial phosphate glass having an erbium lasing ion. The commercial glass is shown at 10 and the glass according to the present invention is shown at 20. The glass composition of the inventive optical amplifier evaluated against the commercial phosphate glass as recorded in FIG. 1 had glass formers of the following composition in mole percent:

| | |
|---|---|
| B₂O₃ | 24% |
| SiO₂ | 24% |
| Al₂O₃ | 20% |
| La₂O₃ | 32% |

It should be understood by those of skill in the art of glass formation that germanium oxide (GeO₂) may be substituted for the boron oxide (B₂O₃) in the same percentage. The inventive glass composition further included 1.8% Er₂O₃ as the lasing element. The inventive glass composition further included 3% by weight Yb₂O₃ as the sensitizing agent and a mixture of 1.5% by weight Nb₂O₅ and 0.5% by weight CeO₂ as the antisolarants. It should be understood that the high gain short length optical amplifier of this invention may be formed as a single fiber or multiple fibers providing significant advantages over the prior art amplifiers.

FIG. 1 shows that the commercial phosphate glass provides adequate amplification in the spectrum ranging from 1525 to 1563 nm, otherwise known as the C-band. However, the inventive glass formulated with the novel composition set forth above proved to provide amplification ranging from 1525 to 1605 nm statistically nearly doubling the amplification spectrum of the commercial graph and also including the L-band (1570-1605 nm) spectrum and the E-band (1563-1570 nm) spectrum as well as the C-band spectrum.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that within the scope of the appended claims, wherein reference numerals are merely for convenience and are not to be in any way limiting, the invention may be practiced otherwise than as specifically described.

What is claimed is:

1. A composition of glass comprising:
a mixture of at least three glass formers selected from the group of oxides of: silicon, germanium, boron, phosphorus, aluminum, tellurium, lanthanum, and lead;
said at least three glass formers each present in a mole percent amount of from about 15% to about 45% based on the total moles of said glass formers in said glass; and
a lasing ion selected from the lanthanide series comprising lanthanide, cerium, praseodymium, neodymium, promethium, samarium, europium, gadolinium, terbium, dysprosium, holmium, erbium, thulium, ytterbium, and lutetium present in a weight percent amount of from about 0.1% to about 30% based on the total weight of said glass.

2. A composition as set forth in claim 1, wherein said at least three glass formers are each present in a mole percent amount of from about 15% to about 35% based on the total moles of said glass formers.

3. A composition as set forth in claim 1, wherein said lasing ion is present in a weight percent amount of from about 1% to about 8% based on the total weight of said glass composition.

4. A composition as set forth in claim 1 further comprising modifiers capable of enhancing ion exchange and enhancing durability of said glass, said modifiers present in a weight percent amount of about 1% to about 30% based on the total weight of said glass.

5. A composition as set forth in claim 4, wherein said modifiers comprise lithium oxide, magnesium oxide, and mixtures thereof.

6. A composition as set forth in claim 5, wherein said lithium oxide is present in a weight percent amount of about 5% to 15% based on the total weight of said glass.

7. A composition as set forth in claim 1 further comprising a sensitizing element present in a weight percent amount of from about 1% to about 30% based on the total weight of said glass.

8. A composition as set forth in claim 7, wherein said sensitizing element is present in a weight percent amount of from about 1% to about 10% based upon the total weight of said glass.

9. A composition as set forth in claim 8, wherein said sensitizing element comprises ytterbium oxide or thulium oxide.

10. A composition as set forth in claim 1 further comprising an antisolarant present in a weight percent amount of from about 1% to about 5% based upon the total weight of said glass.

11. A composition as set forth in claim 10, wherein said antisolarant comprises of niobium oxide, cerium oxide, europium oxide, antimony oxide, titanium oxide, or mixtures thereof.

12. A composition as set forth in claim 10 wherein said antisolarant comprises a mixture of niobium oxide and cerium oxide.

13. A composition of glass comprising:
a mixture of at least three glass formers selected from the group of oxides of: silicon, germanium, boron, phosphorus, aluminum, tellurium, lanthanum, and lead, said at least three glass formers each present in a mole percent amount from about 15% to about 45% based on the total moles of said glass formers in said glass;
a lasing ion selected from the lanthanide series comprising lanthanide, cerium, praseodymium, neodymium, promethium, samarium, europium, gadolinium, terbium, dysprosium, holmium, erbium, thulium, ytterbium, and lutetium and present in a weight percent amount of from about 0.1% to about 30% based on the total weight of said glass; and
at least one modifier capable of enhancing ion exchange and enhancing durability of said glass, said modifier present in a weight percent amount of from about 1% to about 30% based on the total weight of said glass.

14. A composition as set forth in claim 13, wherein each of said at least three glass formers is present in a mole percent amount of from about 15% to about 35% based on the total moles of said glass formers.

15. A composition as set forth in claim 13, wherein said lasing ion is present in a weight percent amount of from about 1% to about 8% based on the total weight of said glass.

16. A composition as set forth in claim 13 wherein said modifier comprises lithium oxide, magnesium oxide, and mixtures thereof.

17. A composition as set forth in claim 16, wherein said modifier is present in a weight percent amount of about 5% to 15% based on the total weight of said glass

18. A composition as set forth in claim 13 further comprising a sensitizing element present in a weight percent amount of from about 1% to about 30% based on the total weight of said glass.

19. A composition as set forth in claim 18, wherein said sensitizing element is present in a weight percent amount of from about 1% to about 10% based on the total weight of said glass.

20. A composition as set forth in claim 16, wherein said sensitizing agent comprises ytterbium oxide or thulium oxide.

21. A composition as set forth in claim 11 further comprising an antisolarant present in a weight percent amount of from about 1% to about 5% base on the total weight of said glass.

22. A composition as set forth in claim 21, wherein said antisolarant comprises at least one of niobium oxide, cerium oxide, europium oxide, antimony oxide, titanium oxide, and mixtures thereof.

23. A composition of glass comprising:
a mixture of at least three glass formers selected from the group of oxides of: silicon, germanium, boron, phosphorus, aluminum, tellurium, lanthanum, and lead, said at least three glass formers each present in a mole percent amount from about 15% to about 45% based on the total moles of said glass formers in said glass;
a lasing ion selected from the lanthanide series comprising lanthanide, cerium, praseodymium, neodymium, promethium, samarium, europium, gadolinium, terbium, dysprosium, holmium, erbium, thulium, ytterbium, and lutetium and present in a weight percent amount of from about 0.1% to about 30% based on the total weight of said glass; and
at least one modifier capable of enhancing ion exchange and enhancing durability of said glass, said modifier present in a weight percent amount of from about 1% to about 30% based on the total weight of said glass; and
a sensitizing element present in a weight percent amount of from about 1% to about 30% based on the total weight of said glass.

24. A composition as set forth in claim 23, wherein said at least three glass formers are each present in a mole percent amount of from about 15% to about 35% based on the total moles of said glass formers.

25. A composition as set forth in claim 23, wherein said lasing ions is present in a weight percent amount of from about 1% to about 8% based on the total weight of said glass.

26. A composition as set forth in claim 23 wherein said modifier comprises lithium oxide or magnesium oxide.

27. A composition as set forth in claim 23, wherein said sensitizing element is present in a weight of from about 1% to about 10% based on the total weight of said glass.

28. A composition as set forth in claim 27, wherein said sensitizing agent comprises ytterbium oxide or thulium oxide.

29. A composition as set forth in claim 23 further comprising an antisolarant present in a weight percent amount of from about 1% to 5% based on the total weight of said glass.

30. A composition as set forth in claim 29, wherein said antisolarant comprises niobium oxide, cerium oxide, europium, antimony oxide, titanium oxide, and mixtures thereof.
